(19) United States
(12) Patent Application Publication
(10) Pub. No.: US 2018/0218290 A1
(43) Pub. Date: Aug. 2, 2018

(54) METHOD AND SYSTEM FOR PARKING-SITE ARRANGEMENT AND RESERVATION

(71) Applicant: Peng Zhao, Shanghai (CN)

(72) Inventor: Peng Zhao, Shanghai (CN)

(21) Appl. No.: 15/423,424

(22) Filed: Feb. 2, 2017

(51) Int. Cl. G06Q 10/02; G07C 9/00

(52) U.S. Cl. CPC G06Q 10/02; G06Q 2240/00; G07C 9/00015; G07C 9/00119

(57) ABSTRACT

A method for reserving a parking space may include steps of a user sending out a parking space reservation request to a remote control center through a communication network; the remote control center receiving and processing the parking space reservation request; the remote control center sending at least one graphical user interface (GUI) associated with at least one parking facility for the user to reserve a parking space; the user selecting a parking space from the GUI; and the remote control center reserving the parking space for the user by lifting a parking barrier thereon. The method for reserving a parking space may further include a step of the remote control center sending out a password to the user to restore the lifted parking barrier to the ground, so the user can park his/her vehicle into the reserved parking space.

### FIELD OF THE INVENTION

The present invention relates to a method and system for parking-site arrangement and reservation, and more particularly to a method and system to reserve a parking space with an electronic device to control a parking barrier on the reserved parking space.

### BACKGROUND OF THE INVENTION

The raid increase of moto vehicles has become a serious problem in many cities around the world. Public transportation, while often convenient, is often limited in scope and operation periods, with many starting points and destinations inadequately served. Bicycles can be used for transportation, but bicycles are inconvenient in hot, cold, or wet weather, difficult traffic conditions on roads with inadequate shoulders, or where the user wants to arrive in formal clothes. As a consequence, although the use of motor vehicles often results in substantial traffic delays, the motor vehicles remains the most popular form of transportation in many urban and suburban environments.

However, the ever-increasing use of motor vehicles and limited space for parking, particularly in urban areas, has led to serious problems in parking management. In general, parking in parking lots and garages at public events, airports, stadiums, commuter lots, office buildings or other large parking areas can be problematic and time-consuming because it can be difficult to identify where available parking spaces are located, particularly in lots that are partially filled or almost filled to capacity. Therefore, there remains a need for a new and improved parking space reservation and arrangement system to overcome the problems stated above.

### SUMMARY OF THE INVENTION

It is an object of the present invention to provide a parking space reservation system that a person can reserve a parking space in a specific parking lot with his/her electronic device.

It is another object of the present invention to provide a parking space reservation system that a parking barrier will be lifted to block the reserved parking space until the person who reserves the parking space arrives.

It is a further object of the present invention to provide a parking space reservation system that a control center can send a password to the user to restore the parking barrier to the ground.

It is still a further object of the present invention to provide a parking space reservation system that a control center can send a “hidden key” to the user's mobile device, so the user can pair the mobile device with the corresponding parking barrier to restore the parking barrier to the ground.

In one aspect, a parking space reservation system may include at least one electronic device and a control center. In one embodiment, the communication between the electronic device and the control center is through a communication network. In another embodiment, the electronic device may include, but not limited to, a mobile phone, a computer and a personal digital assistant (PDA). The electronic device is configured to send an inquiry to the control center through the communication network regarding the availability of the parking spaces in one or more parking facilities, and the control center can process and respond the user's inquiry regarding the availability of the parking spaces.

More specifically, the control center may include a server that is electronically couple with a GPS module and a map database. According to this embodiment, the map database has stored therein parking lot information of a plurality of parking facilities such information including vacancy capacity, full capacity, used rate, and fee rate.

Each of the electronic devices has a global positioning device and a wireless communication device. According to this embodiment, the global positioning device is adapted to calculate the current position Lc=(Xc, Yc) of the corresponding electronic device. By means of the wireless communication device, the electronic device can send out a park reservation request R, which may include the information of the current position Lc of the associated electronic device and the identification code thereof.

When the control center receives the park reservation request R from the electronic device through the communication network, it starts to search the map database having the parking lot information subject to the information of the current location Lc of the electronic device contained in the received park reservation request R, and then sends back the parking facility information among the parking facilities that may be suitable for the user.

In an exemplary embodiment, the control center may send out a graphical user interface (GUI) of one specific parking facility for the user to select a parking space. The parking space GUI may include a plurality of reserved parking spaces, a plurality of parked spaces and a plurality of available spaces. It is noted that the parking lot information on the GUI is dynamic and the control center is configured to update the status thereof, and the user can use the electronic device to reserve one or more parking spaces. It is also noted that a parking barrier is disposed on the ground of each parking space and it can be controlled by the control center to lift up or restore to the ground.

More specifically, the user can use the electronic device to select and reserve an available and preferred parking space. For example, if the user decides to reserve a parking space, the user can simply select this parking space on the electronic device, and the selection would be transmitted to the control center through the communication network, and the control center can lift a parking barrier that is disposed on the parking space to complete the parking space reservation.

Once the parking space is reserved, in one embodiment, the control center may send out a message to the user to provide a password to restore the parking barrier to the ground when the user arrives the reserved parking space, so the user can park the vehicle into the reserved parking space. In another embodiment, the control center may send a “hidden key” to the user's mobile phone (or PDA) so the user can use the mobile phone to pair with the corresponding parking barrier through Bluetooth, for example, to restore the parking barrier to the ground and the user's vehicle can be parked at the corresponding parking space.

In a further embodiment, the user can reserve the parking space for another person. The user can simply send the password to restore the parking barrier to another person. In still a further embodiment, the user can reserve the parking space for another person by providing the person's phone number to the control center, and the control center can directly send the hidden key to that person's mobile phone that can be used to pair with the parking barrier to restore it to the ground.

In another aspect, a method for reserving a parking space may include steps of a user sending out a parking space reservation request to a remote control center through a communication network; the remote control center receiving and processing the parking space reservation request; the remote control center sending at least one graphical user interface (GUI) associated with at least one parking facility for the user to reserve a parking space; the user selecting a parking space from the GUI; and the remote control center reserving the parking space for the user by lifting a parking barrier thereon.

The method for reserving a parking space in the present invention may further include a step of the remote control center sending out a password to the user to restore the lifted parking barrier to the ground, so the user can park his/her vehicle into the reserved parking space. In a further embodiment, the method for reserving a parking space in the present invention may further include a step of the remote control center sending out a pairing information to the user's mobile device to restore the lifted parking barrier by pairing the mobile device with the parking barrier to restore it to the ground.

### BRIEF DESCRIPTION OF THE DRAWINGS

FIG. 1 is a schematic view of a parking reservation and arrangement system in the present invention.

FIG. 2 is a schematic view for reserving a parking space that is sent from the control center of the parking reservation and arrangement system in the present invention.

FIG. 3a is a schematic view of a user interface illustrating a password to restore the lifted parking barrier at the reserved parking space.

FIG. 3b is a schematic view of a user interface illustrating a hidden key to restore the lifted parking barrier at the reserved parking space.

FIG. 4 illustrates another aspect of a method for reserving parking spaces in the present invention.

FIG. 4a is one embodiment of the method for reserving parking spaces in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

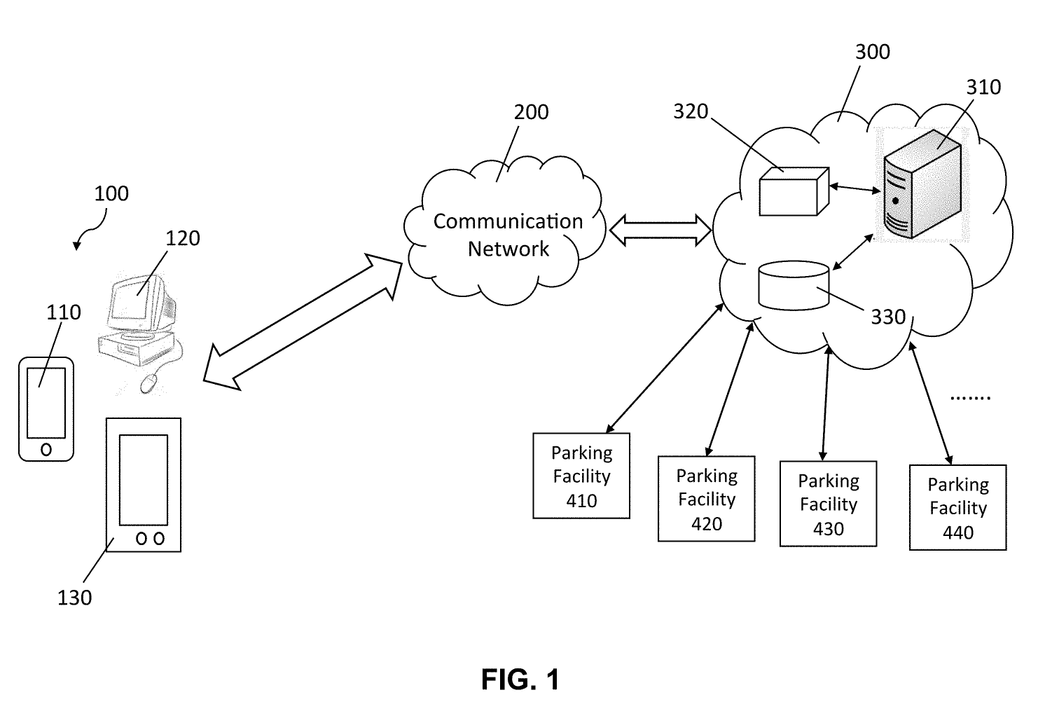

In one aspect, as shown in FIG. 1, a parking space reservation system may include at least one electronic device 100 and a control center 300. In one embodiment, the communication between the electronic device 100 and the control center 300 is through a communication network 200, e.g. the Internet. In another embodiment, the electronic device 100 may include, but not limited to, a mobile phone 110, a computer 120 and a personal digital assistant (PDA) 130. The electronic device 100 is configured to send an inquiry to the control center 300 through the communication network 200 regarding the availability of the parking spaces in one or more parking facilities, and the control center 300 can process and respond the user's inquiry regarding the availability of the parking spaces.

More specifically, the control center 300 may include a server 310 that is electronically couple with a GPS module 320 and a map database 330. According to this embodiment, the map database 330 has stored therein a plurality of parking lot information of respective parking facilities 410, 420, 430, 440 . . . such information including vacancy capacity, full capacity, used rate, and fee rate.

Each of the electronic devices 100 has a global positioning device and a wireless communication device. According to this embodiment, the global positioning device is adapted to calculate the current position Lc=(Xc, Yc) of the corresponding electronic device. By means of the wireless communication device, the electronic device 100 can send out a park reservation request R, which may include the information of the current position Lc of the associated electronic device and the identification code thereof.

When the control center 300 receives the park reservation request R from the electronic device 100 through the communication network 200, it starts to search the map database 330 having the parking lot information subject to the information of the current location Lc of the electronic device 100 contained in the received park reservation request R, and then sends back the parking facility information among the parking facilities (410, 420, 430, 440 . . . ) that may be suitable for the user.

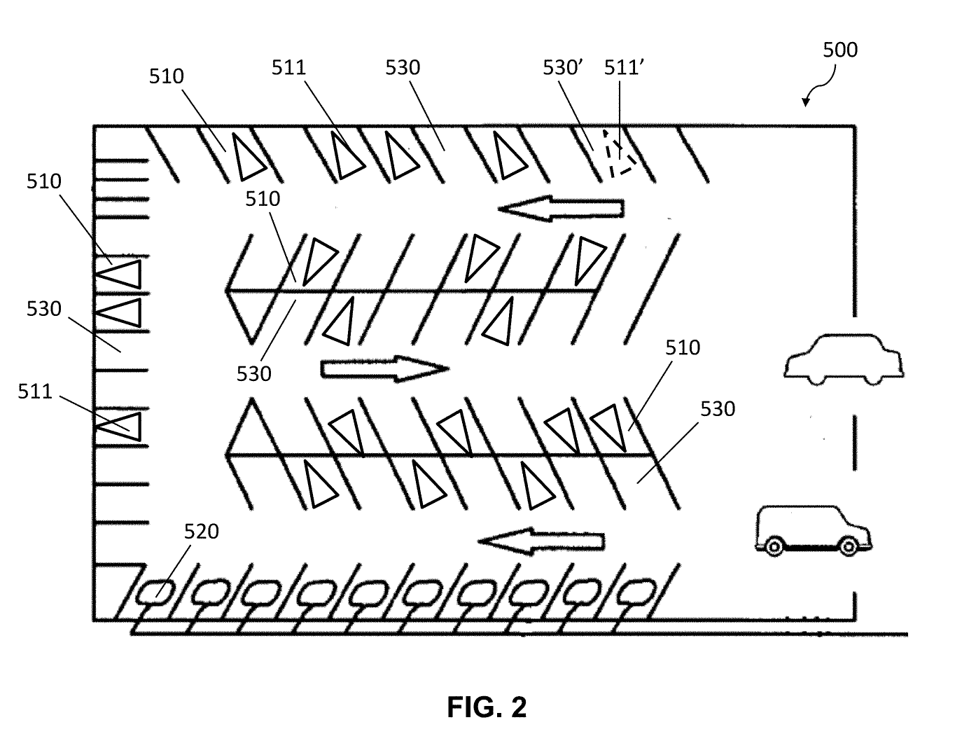

In an exemplary embodiment, the control center may send out a graphical user interface (GUI) 500 of one specific parking facility as shown in FIG. 2 for the user to select a parking space. The parking space GUI 500 may include a plurality of reserved parking spaces 510, a plurality of parked spaces 520 and a plurality of available spaces 530. It is noted that the parking lot information on the GUI 500 is dynamic and the control center 300 is configured to update the status thereof, and the user can use the electronic device 100 to reserve one or more parking spaces. It is also noted that a parking barrier 511 is disposed on the ground of each parking space and it can be controlled by the control center 300 to lift up or restore to the ground.

More specifically, the user can use the electronic device 100 to select and reserve an available and preferred parking space. For example, as shown in FIG. 2, if the user decides to reserve a parking space 530′, the user can simply select this parking space on the electronic device 100, and the selection would be transmitted to the control center 300 through the communication network 200, and the control center 300 can lift a parking barrier 511′ that is disposed on the parking space 530′ to complete the parking space reservation.

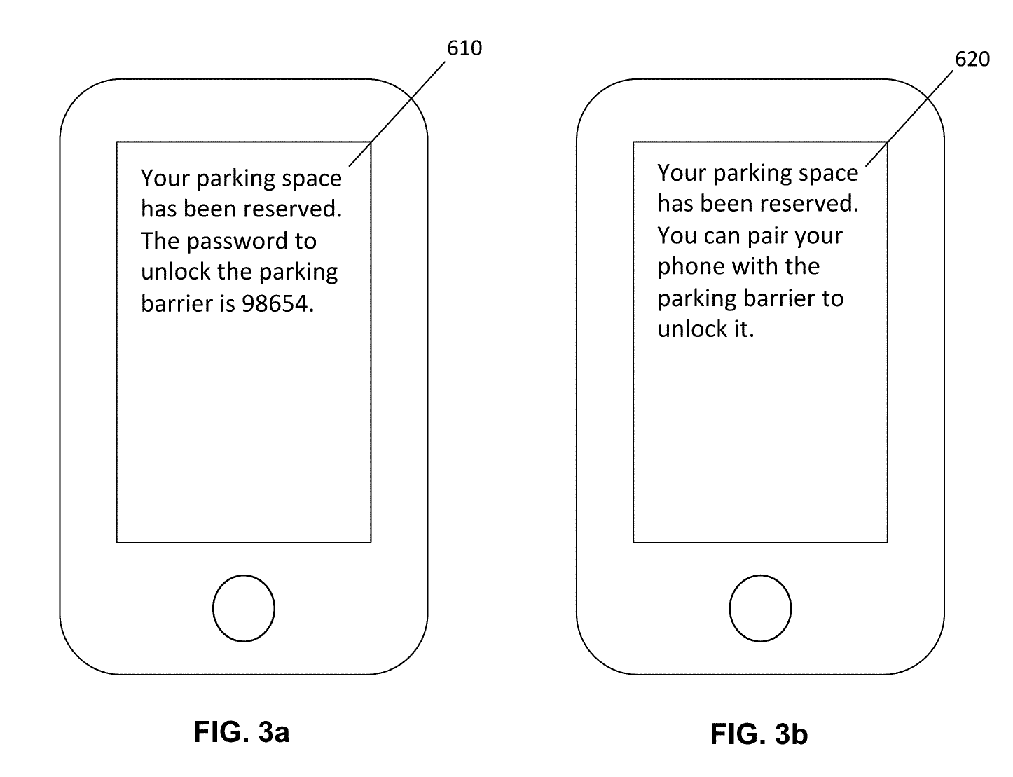

Once the parking space is reserved, in one embodiment, the control center 300 may send out a message 610 to the user as shown in FIG. 3a to provide a password to restore the parking barrier 511 to the ground when the user arrives the reserved parking space, so the user can park the vehicle into the reserved parking space. In another embodiment, as shown in FIG. 3b, the control center 300 may send a “hidden key” 620 to the user's mobile phone 110 (or PDA 130) so the user can use the mobile phone 110 to pair with the corresponding parking barrier 511 through Bluetooth, for example, to restore the parking barrier 511 to the ground and the user's vehicle can be parked at the corresponding parking space.

In a further embodiment, the user can reserve the parking space for another person. The user can simply send the password to restore the parking barrier 511 as shown in FIG. 3a to another person. In still a further embodiment, the user can reserve the parking space for another person by providing the person's phone number to the control center 300, and the control center 300 can directly send the hidden key to that person's mobile phone that can be used to pair with the parking barrier 511 to restore it to the ground.

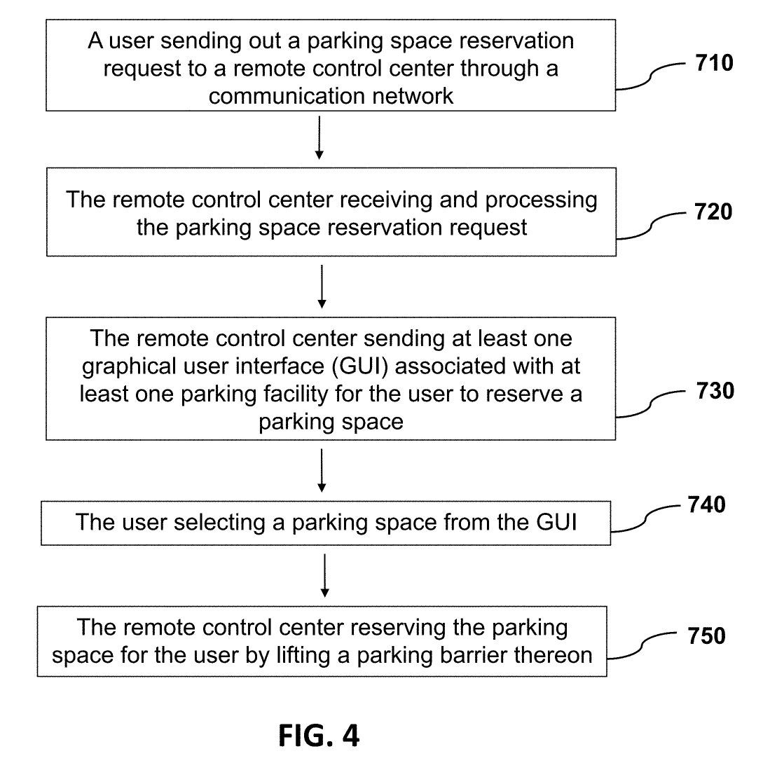

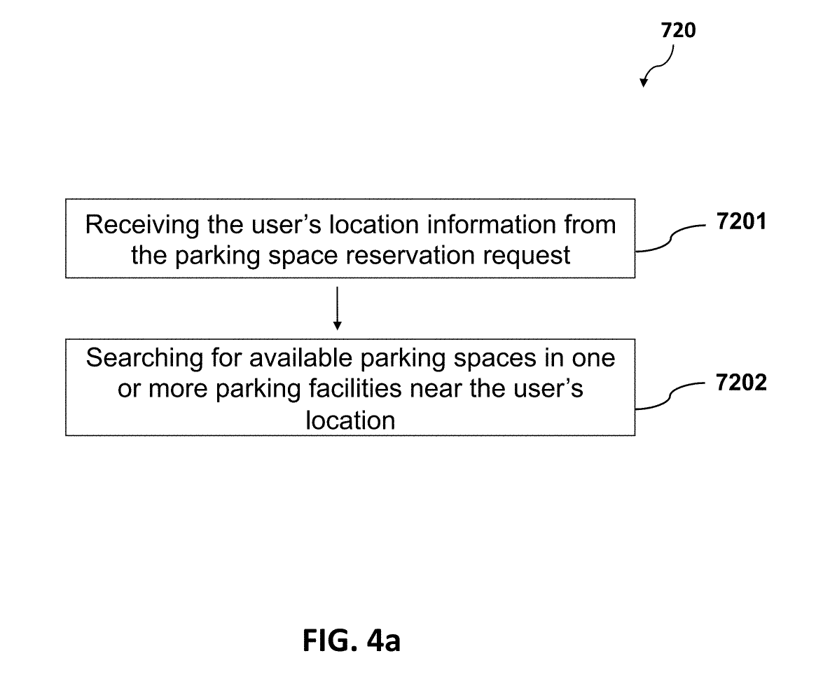

In another aspect, as shown in FIG. 4, a method for arranging and reserving a parking space may include steps of a user sending out a parking space reservation request to a remote control center through a communication network 710; the remote control center receiving and processing the parking space reservation request 720; the remote control center sending at least one graphical user interface (GUI) associated with at least one parking facility for the user to reserve a parking space 730; the user selecting a parking space from the GUI 740; and the remote control center reserving the parking space for the user by lifting a parking barrier thereon 750.

In one embodiment, the step of the remote control center receiving and processing the parking space reservation request 720 may include steps of receiving the user's location information from the parking space reservation request 7201 and searching for available parking spaces in one or more parking facilities near the user's location 7202.

In another embodiment, the step of the user selecting a parking space from the GUI 740 may include a step of the user tapping an available and preferred parking space from the GUI 7401 and transmitting the selection to the remote control center 7402.

The method for reserving a parking space in the present invention may further include a step of the remote control center sending out a password to the user to restore the lifted parking barrier to the ground 760, so the user can park his/her vehicle into the reserved parking space. In a further embodiment, the method for reserving a parking space in the present invention may further include a step of the remote control center sending out a pairing information to the user's mobile device to restore the lifted parking barrier by pairing the mobile device with the parking barrier to restore it to the ground 770.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A method for arranging and reserving a parking space comprising steps of:
a user sending out a parking space reservation request to a remote control center through a communication network;
the remote control center receiving and processing the parking space reservation request;
the remote control center sending at least one graphical user interface (GUI) associated with at least one parking facility for the user to reserve a parking space;
the user selecting a parking space from the GUI; and
the remote control center reserving the parking space for the user by lifting a parking barrier thereon.

2. The method for arranging and reserving a parking space of claim 1, wherein the communication network includes the Internet.

3. The method for arranging and reserving a parking space of claim 1, wherein the step of the remote control center receiving and processing the parking space reservation request includes steps of receiving the user's location information from the parking space reservation request; and searching for available parking spaces in one or more parking facilities near the user's location.

4. The method for arranging and reserving a parking space of claim 1, wherein the step of the user selecting a parking space from the GUI includes a step of the user tapping an available and preferred parking space from the GUI and transmitting the selection to the remote control center.

5. The method for arranging and reserving a parking space of claim 3, wherein the step of the user selecting a parking space from the GUI includes a step of the user tapping an available and preferred parking space from the GUI and transmitting the selection to the remote control center.

6. The method for arranging and reserving a parking space of claim 1, further comprising a step of the remote control center sending out a password to the user to restore the lifted parking barrier to the ground.

7. The method for arranging and reserving a parking space of claim 5, further comprising a step of the remote control center sending out a password to the user to restore the lifted parking barrier to the ground.

8. The method for arranging and reserving a parking space of claim 1, further a step of the remote control center sending out a pairing information to the user's mobile device to restore the lifted parking barrier by pairing the mobile device with the parking barrier to restore it to the ground.

9. The method for arranging and reserving a parking space of claim 5, further a step of the remote control center sending out a pairing information to the user's mobile device to restore the lifted parking barrier by pairing the mobile device with the parking barrier to restore it to the ground.
